(19) United States
(12) Patent Application Publication
(10) Pub. No.: US 2002/0137823 A1
(43) Pub. Date: Sep. 26, 2002

(54) Polyalkylene terephthalate compositions stabilized with phosphorous acid esters

(76) Inventors: Matthias Bienmuller, Krefeld (DE); Karsten-Josef Idel, Krefeld (DE); Friedemann Paul, Bergisch Gladbach (DE)

Correspondence Address: BAYER CORPORATION, PATENT DEPARTMENT, 100 BAYER ROAD, PITTSBURGH, PA, 15205, US

(21) Appl. No.: 10/014,391

(22) Filed: Oct. 22, 2001

(30) Foreign Application Priority Data
Oct. 25, 2000 (DE) 10052805.8

(51) Int. Cl. C08K 5/49

(52) U.S. Cl. 524/128

(57) ABSTRACT

A stabilized molding composition containing A) polyalkylene terephthalate and B) a small amount of an ester of phosphorous acid is disclosed. The composition which may further contain any of fillers, reinforcing agents, flame-proofing additives, aromatic poly(ester)-carbonate, elastomeric modifiers, and further conventional additives exhibits improved resistance to thermal hydrolysis.

### FIELD OF THE INVENTION

The invention relates to compositions based on polyalkylene terephthalate that contain minor amounts of phosphorous acid esters.

### SUMMARY OF THE INVENTION

A stabilized molding composition containing A) polyalkylene terephthalate and B) a small amount of an ester of phosphorous acid is disclosed. The composition which may further contain any of fillers, reinforcing agents, flame-proofing additives, aromatic poly(ester)carbonate, elastomeric modifiers, and further conventional additives exhibits improved resistance to thermal hydrolysis.

### BACKGROUND OF THE INVENTION

Phosphorous acid esters are added to polycarbonate molding compositions and polyester molding compositions to stabilize them against thermal stress, in particular to prevent discoloration occurring in the production of molded articles (e.g. DE-A 2 140 207, DE-A 2 255 639, DE-A 2 615 341).

Phosphorous acid esters are added in particular for the purposes of stabilization to polyalkylene terephthalates that are subjected to thermal and/or oxidative stress or powerful UV radiation. The stabilization reduces the polymer degradation during tempering in hot air, which is why for practical use important properties such as for example toughness and extensibility do not fall to such a low level as in the case of unstabilized molding compositions (DE-A 2 615 341).

Phosphorous acid esters are also added to polymer blends of polyalkylene terephthalate and polycarbonate that exhibit a good toughness as well as thermal stability, in order to provide a better lacquerability and lacquer adhesion (EP-A 0 373 465).

In addition to the stabilization of polymer blends against thermal stress, a stabilization against hydrolysis is also desirable. A typical application of molding compositions based on polyethylene terephthalate in which an outstanding resistance to hydrolysis is required are extruded light guide sheathings. In order to be able to protect glass fibers reliably against mechanical damage even after several years' use in a damp environment, an improved resistance to hydrolysis is necessary.

### DETAILED DESCRIPTION OF THE INVENTION

It has now been found that with compositions based on polyalkylene terephthalates that contain minor amounts of phosphorous acid esters a significant improvement in the hydrolysis stability is observed.

The invention accordingly provides compositions containing

A) polyalkylene terephthalate, particularly preferably polybutylene terephthalate,

B) 0.041 to 0.095 part by weight (herein pbw), preferably 0.051 to 0.075 part by weight, particularly preferably 0.055 part by weight to 0.065 part by weight (referred to the overall weight of the composition) of at least one of B.1) and B.2, where B.1) is a phosphorous acid ester the molecule of which contains at least one oxetane group as well as at least one radical of a dihydric or polyhydric phenol, and where B.2 is an ester of phosphorous acid the molecule of which contains at least one phosphorus-bound hydroxyl group (P—OH) and at least one radical of a dihydric or polyhydric phenol, and

optionally at least one further component selected from

C) fillers and reinforcing agents,

D) flame-proofing additives,

E) aromatic poly(ester)carbonate,

F) elastomeric modifiers, and

G) further conventional additives.

The content of polyalkylene terephthalate according to component A is in general 31 to 99.959 parts by weight, preferably 61 to 99.959 parts by weight, particularly preferably 91 to 99.959 parts by weight, especially preferably 99.6 to 99.959 parts by weight, referred to 100 parts by weight of the composition.

The content of phosphorous acid esters according to component B is in general 0.041 to 0.095 part by weight, preferably 0.051 to 0.075 part by weight, particularly preferably 0.055 to 0.065 part by weight, referred to 100 parts by weight of the overall composition.

The content of fillers and reinforcing agents according to component C is in general 6 to 69 parts by weight, preferably 11 to 31 parts by weight, particularly preferably 16 to 25 parts by weight, referred to 100 parts by weight of the overall composition.

The content of flame-proofing additives according to component D is in general 5 to 25 parts by weight, preferably 9 to 19 parts by weight referred to 100 parts by weight of the overall composition.

The content of aromatic poly(ester)carbonate according to component E is in general 6 to 69 parts by weight, preferably 21 to 56 parts by weight, particularly preferably 31 to 50 parts by weight, referred to 100 parts by weight of the overall composition.

The content of elastomeric modifiers according to component F is in general 5 to 29 parts by weight, preferably 7 to 19 parts by weight, particularly preferably 9 to 15 parts by weight, referred to 100 parts by weight of the overall composition.

The content of conventional additives according to component G is in general 0.01 to 5 parts by weight, preferably 0.05 to 3 parts by weight, particularly preferably 0.1 to 0.9 part by weight, referred to 100 parts by weight of the overall composition.

Particularly preferred are compositions containing the components A) and B) as well as optionally conventional additives, for example and preferably nucleating agents.

Component A

The polyalkylene terephthalates of the component A are reaction products of aromatic dicarboxylic acids or their reactive derivatives, such as dimethyl esters or anhydrides, and aliphatic, cycloaliphatic or araliphatic diols as well as mixtures of these reaction products.

Preferred polyalkylene terephthalates contain at least 80 wt. %, preferably at least 90 wt. %, referred to the dicarboxylic acid component, of terephthalic acid radicals, and at least 80 wt. %, preferably at least 90 mole %, referred to the diol component, of ethylene glycol and/or propanediol-1,3 and/or butanediol-1,4 radicals.

The preferred polyalkylene terephthalates may contain, in addition to terephthalic acid radicals, also up to 20 mole %, preferably up to 10 mole %, of radicals of other aromatic or cycloaliphatic dicarboxylic acids with 8 to 14 C atoms or aliphatic dicarboxylic acids with 4 to 12 C atoms, such as for example radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred polyalkylene terephthalates may contain, in addition to ethylene glycol radicals or butanediol-1,4 radicals, also up to 20 mole %, preferably up to 10 mole %, of other aliphatic diols with 3 to 12 C atoms or cycloaliphatic diols with 6 to 21 C atoms, for example radicals of propanediol-1,3, 2-ethylpropanediol-1,3, neopentyl glycol, pentanediol-1,5, hexanediol-1,6, cyclohexanedimethanol-1,4, 3-ethylpentanediol-2,4, 2-methylpentanediol-2,4, 2,2,4-trimethylpentanediol-1,3, 2-ethylhexanediol-1,3, 2,2-diethylpropanediol-1,3, hexanediol-2,5, 1,4-di-(β-hydroxyethoxy)-benzene, 2,2-bis-(4-hydroxycyclohexyl)-propane, 2,4-dihydroxy-1,1,3,3-tetramethylcyclobutane, 2,2-bis-(4-β-hydroxyethoxyphenyl)-propane and 2,2-bis-(4-hydroxypropoxyphenyl)-propane (DE-A 2 407 674, 2 407 776, 2 715 932).

The polyalkylene terephthalates may be branched by incorporating relatively small amounts of trihydric or tetrahydric alcohols or tribasic or tetrabasic carboxylic acids, for example according to DE-A 1 900 270 and U.S. Pat. No. 3,692,744. Examples of preferred branching agents are trimesic acid, trimellitic acid, trimethylolethane and trimethylolpropane, and pentaerythritol.

Particularly preferred are polyalkylene terephthalates that have been produced simply from terephthalic acid and its reactive derivatives (for example its dialkyl esters) and ethylene glycol and/or butanediol-1,4, and mixtures of these polyalkylene terephthalates.

Mixtures of polyalkylene terephthalates contain 1 to 50 wt. %, preferably 1 to 30 wt. %, of polyethylene terephthalate, and 50 to 99 wt. %, preferably 70 to 99 wt. %, of polybutylene terephthalate.

The polyalkylene terephthalates can be produced by known methods (see for example Kunststoff-Handbuch, Vol. VIII, p. 695 et seq., Carl-Hanser-Verlag, Munich 1973).

Preferred polyalkylene terephthalates are polybutylene terephthalate, polytrimethylene terephthalate and/or polyethylene terephthalate. Polybutylene terephthalate is particularly preferred.

The polyalkylene terephthalates are characterised by an intrinsic viscosity IV of 0.55 to 1.95 cm³/g, preferably 0.85 to 1.85 cm³/g, particularly preferably 1.15 to 1.65 cm³/g, most particularly preferably 1.35 to 1.55 cm³/g, and especially preferably 1.41 to 1.42 cm³/g.

Component B

Phosphorous acid esters within the context of the invention include esters of phosphorous acid that contain per molecule at least one oxetane group as well as at least one radical of a dihydric or polyhydric phenol.

Preferred are phosphorous acid esters of the formula (I)

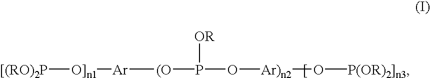

in which

n₁ is 1 or an integer>1, preferably 1 to 9,

n₂ is 0 or an integer>0, preferably 0 to 2,

n₃ is 1 or an integer>1, preferably 1 to 9,

R denotes alkyl, aralkyl, cycloalkyl, aryl or heteroaryl, at least one of the radicals R denoting a radical of a monohydric alcohol containing at least one oxetane group Y, and

Ar denotes aryl, which may optionally be substituted by alkyl and/or hydroxy, and in which for n₂≠0 Ar may be identical or different,

and compounds selected from

tris-[(3-ethyloxetanyl-3)-methyl]-phosphite,

tris-[(3-pentyloxetanyl-3)-methyl]-phosphite,

phenyl-bis-[(3-ethyloxetanyl-3)-methyl]-phosphite,

2-phenoxy-spiro(1,3,2-dioxaphosphorinane-5,3′-oxetane),

3,3-bis-[spiro(oxetane-3′,5″-(1″,3″,2″-dioxaphosphorinane-2″))-oxymethyl]-oxetane.

Suitable as radical R in formula (I) are for example: C₁-C₁₈ alkyl, mononuclear or polynuclear C₃-C₁₀ cycloalkyl, phenyl C₁-C₂ alkyl, mononuclear or polynuclear C₆-C₁₈ aryl such as phenyl, naphthyl, anthracyl, phenanthryl, biphenyl, phenoxyphenyl or fluorenyl, as well as heterocyclic compounds such as for example tetrahydrofuryl, wherein the aryl radicals may be substituted for example by alkyl and/or halogen, such as C₁-C₁₈ alkyl, chlorine and/or bromine.

The radical R may also be a derivative of a C₁-C₆ monohydric alcohol containing one or more oxetane groups P.

The oxetane group Y is understood to denote the heterocyclic radical

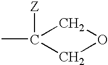

wherein Z may for example be H, CH₃, C₂H₅, n-C₅H₁₁, —CH₂—C₅H₁₁, —CH₂—O—C₆H₁₃ or CH₂—O—C₂H₅.

The radical R in formula (I) may itself also denote the oxetane group Y, for example where Z=H.

The radical Ar may be derived from phenols with two phenolic hydroxyl groups. The radical Ar is preferably derived from the following compounds: hydroquinone, resorcinol, pyrocatechol, di-t-butylpyrocatechol, 4,4′-dihydroxydiphenyl, bis-(hydroxyphenyl)-alkanes such as for example C₁-C₈ alkylene bisphenols and C₂-C₈ alkylidene bisphenols, bis-(hydroxyphenyl)-cycloalkanes such as for example C₅-C₁₅ cycloalkylene bisphenols and C₅-C₁₅ cycloalkylene bisphenols, α,α′-bis-(hydroxyphenyl)-diisopropylbenzene as well as the corresponding nuclear-alkylated or nuclear-halogenated compounds, for example bis-(4-hydroxyphenyl)-propane-2,2 (bisphenol A), bis-(4-hydroxy-3,5-dichlorophenyl)-propane-2,2 (tetrachloro-bisphenol A), bis-(4-hydroxy-3,5-dibromophenyl)-propane-2,2 (tetrabromo-bisphenol A), bis-(4-hydroxy-3,5-dimethylphenyl)-propane-2,2 (tetramethyl-bisphenol A), bis-(4-hydroxy-3-methylphenylpropane-2,2-cyclohexane-1,1 (bisphenol Z), as well as α,α′-bis-(4-hydroxyphenyl)-p-diisopropylbenzene, dihydroxynaphthalenes and dihydroxyanthracenes.

Suitable as phenols with more than two phenolic hydroxyl groups include phloroglucinol and pyrogallol.

Among the compounds the compounds of the formula (I) the ones derived from 2,2-bis-(hydroxyphenyl) alkanes and oxetane group-containing monohydric alcohols are preferred, i.e. compounds of the formula (I) in which Ar corresponds to a radical of the formula (II)

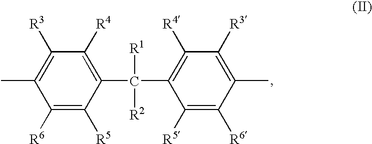

wherein

R¹ and R² are identical or different and denote H, C₁-C₁₈ alkyl, mononuclear or polynuclear C₃-C₆ cycloalkyl or mononuclear or polynuclear C₆-C₁₈ aryl,

R³, R^{3′}, R⁴, R^{4′}, R⁵, R^{5′}, R⁶ and R^{6′} are identical or different and denote H, C₁-C₁₈ alkyl, mononuclear or polynuclear C₃-C₆ cycloalkyl, mononuclear or polynuclear C₆-C₁₈ aryl, C₁-C₁₈ alkoxy, C₁-C₁₈ aryloxy or halogen.

The alkyl substituents suitable as substituent for compounds of the formula (II) may be unbranched or branched, saturated or unsaturated, suitable aryl substituents may for example be phenyl or biphenyl, and Cl or Br are preferred as halogen substituents.

*The compounds of the formula (I) in which Ar corresponds to a radical of the formula (II) are obtained by reacting the corresponding bisphenols of the formula (III)

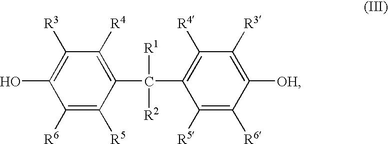

wherein

R¹ to R⁶ as well as R^{3′} to R^{6′} have the aforementioned meanings, in the manner described in DE-OS 2 255 639.

The compounds of the claimed type are high boiling point liquids, resins or solids. They are readily soluble in organic solvents, in particular in the solvents used in the production of polycarbonates, and are therefore particularly suitable for use as stabilizers in high viscosity polycarbonates that are produced and/or processed at high temperatures.

The compounds, examples of which are shown hereinafter, may be produced and used individually as well as in mixtures. The phosphites may have a linear or branched structure.

The following is a representative selection of suitable compounds:

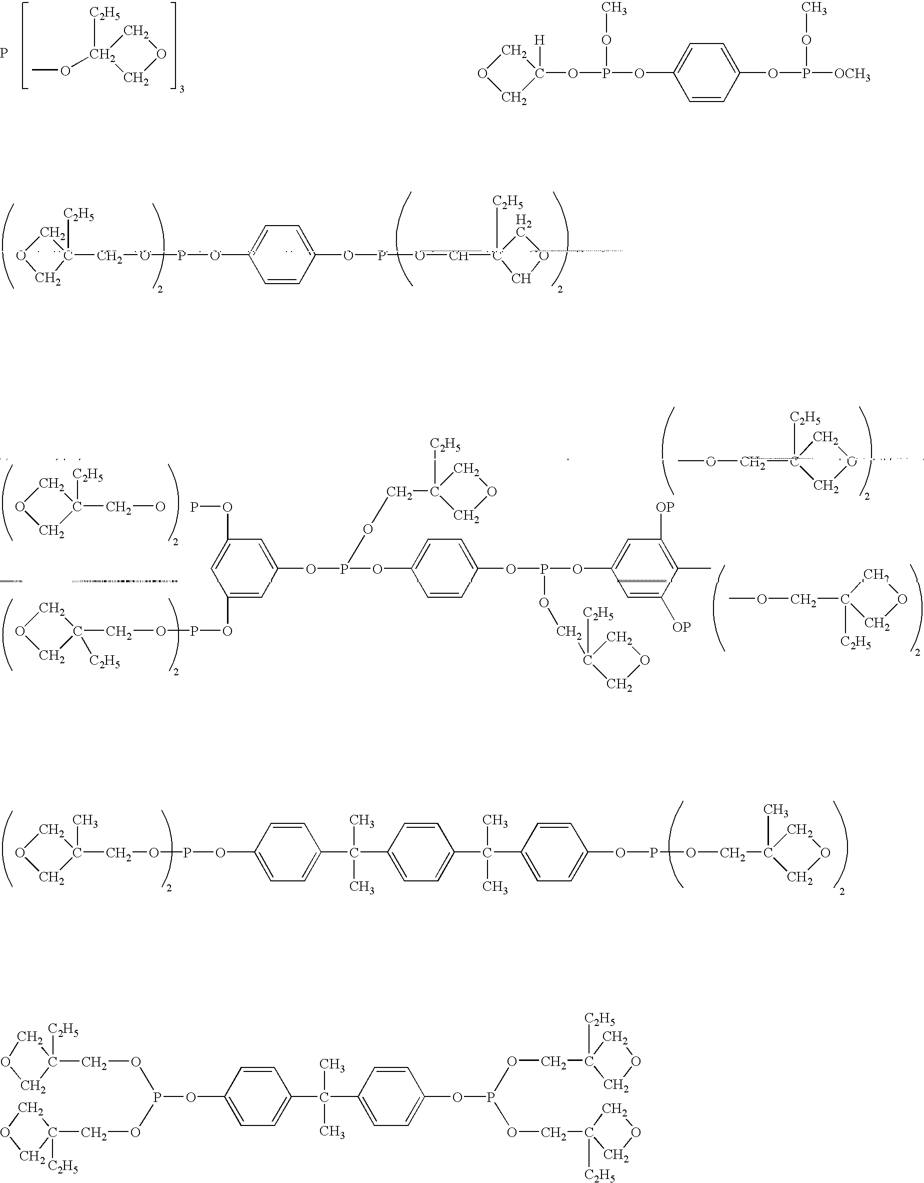

The phosphorous acid esters of the formula (I) are known and may be prepared by the processes described in DE-A 22 55 639 (=U.S. Pat. No. 4,073,769 and 4,323,501, both incorporated herein by reference). The neutral esters of phosphorous acid that are furthermore mentioned are also known (DE-A 2 140 207, corresponding to U.S. Pat. No. 3,794,629 incorporated herein by reference).

The production of the phosphites according to the invention of the formula (I), in which R is the radical of an oxetane group-containing monohydric alcohol, may be carried out for example by reacting a mixture consisting of an oxetane group-containing monohydric alcohol R—OH and an aryl compound containing two or more phenolic hydroxyl groups, for example a bisphenol of the formula (III), with triphenyl phosphite in the presence of an alkaline catalyst, the desired product being formed with the elimination of phenol. Temperatures of 100°-180° C. may be mentioned as reaction temperature, and NaOH, NaOCH₃, Na phenolate, Na₂CO₃, KOH and tributylamine may be mentioned as catalysts.

The reaction may be carried out in bulk or with the addition of solvents. The molar ratio of the reactants, namely oxetane group-containing monohydric alcohol R—OH, aryl compound and triphenyl phospite, is calculated from the end product of the formula (I) that is to be produced.

The oxetane group-containing phosphites according to component B) may be added to the polymers either individually or also in combination with one another in the aforementioned concentrations.

The production of the stabilized polymers may be carried out by adding the phosphite either in pure form to the molten polymer or optionally in solution in a low boiling point solvent to the polymer. The stabilized polymers can also be produced by impregnating the powdered or granulated polymer with the phosphite (optionally with a solution thereof in a solvent such as for example isopropanol) in a suitable mixing apparatus. The polymers according to the invention can also be produced by batch addition during the production/compounding process (formation of the batch by incorporating the phosphite into the polymer for example by extrusion), optionally as a batch based on polyalkylene terephthalate or optionally as a batch based on polycarbonate. The batch may be granular or pulverulent. The working-up and processing of the polymers according to the invention is carried out according to known techniques.

The same comments apply as regards the metering in of the phosphite during the production of the polymer according to known processes in the melt or in a solvent.

Phosphorous acid esters within the context of the present invention are also esters of phosphorous acid that per molecule contain at least one phosphorus-bound hydroxyl group (P—OH) as well as at least one radical of a dihydric or polyhydric phenol. Phosphorous acid esters of the formula (IV) are preferred

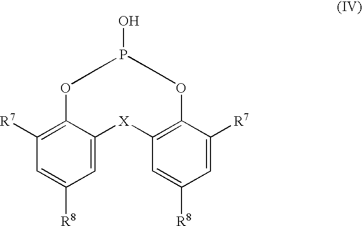

wherein

R⁷ and R⁸ are identical or different and denote C₁-C₉ alkyl, C₅-C₆ cycloalkyl, C₇-C₉ aralkyl or C₆-C₁₀ aryl and

X denotes —S— or R⁹—CH where R⁹ denotes hydrogen, C₁-C₆ alkyl or C₅-C₆ cycloalkyl.

Suitable and preferred as alkyl radicals are for example: methyl, ethyl, propyl, isononyl, and as aralkyl radicals:

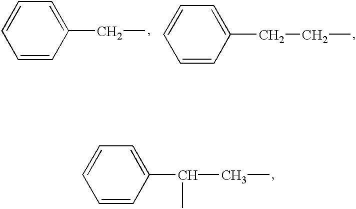

as cycloalkyl radicals: cyclopentyl, cyclohexyl, as aryl radicals: phenyl, naphthyl.

Phosphorous acid esters of the formula (IV) are preferably used in which R⁷ and R⁸ denote a benzyl, α-methylbenzyl, α,α-dimethylbenzyl, methyl, ethyl, isopropyl, tert.-butyl, tert.-amyl, isononyl, cyclopentyl or cyclohexyl radical, and X denotes

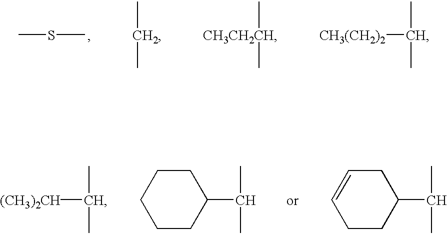

Particularly preferred is the phosphorous acid ester of the formula (IV) in which X denotes methylene, R⁷ denotes cyclohexyl and R⁸ denotes methyl, i.e. [4,8-dicyclo-hexyl-6-hydroxy-2,10-dimethyl-12H-dibenzo(d,g)(1,3,2)-dioxaphosphocine]

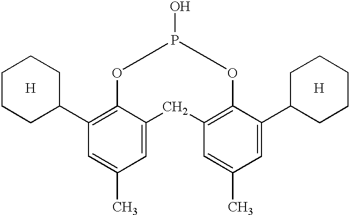

The phosphorous acid esters of the formula (IV) may be produced in a known manner by reacting triphenyl phosphite with corresponding dihydroxy compounds in the presence of water (see for example DE-A 29 29 229).

A mixture of several phosphorous acid esters may also be used.

Within the context of the invention phosphorous acid esters are particularly preferred that contain, per molecule, at least one oxetane group as well as at least one radical of a dihydric or polyhydric phenol.

Component C

The component C is fillers and/or reinforcing agents.

As fibrous or particulate fillers and reinforcing agents there may for example be added glass fibers, glass spheres, glass fabric, glass mats, carbon fibers, aramide fibers, potassium titanate fibers, natural fibers, amorphous silicic acid, magnesium carbonate, barium sulfate, feldspar, mica, silicates, quartz, talcum, kaolin, titanium dioxide, wollastonite, inter alia, which may also be surface-treated. Preferred reinforcing agents are commercially available glass fibers. The fillers and reinforcing agents may be provided with a suitable sizing system or a bonding agent, for example silane-based systems.

Glass fibers are preferably used.

Component D

Organic halogen compounds with synergists or commercially available organic nitrogen compounds or organic/inorganic phosphorus compounds may be used, individually or as a mixture, as flame-proofing agents.

Mineral flame-proofing additives such as magnesium hydroxide or hydrated Ca—Mg carbonates (e.g. DE-A 4 236 122) may also be used. The following may be mentioned as examples of halogen-containing, in particular brominated and chlorinated compounds: ethylene-1,2-bistetrabromophthalimide, epoxidised tetrabromobisphenol A resin, tetrabromobisphenol A oligocarbonate, tetrachlorobisphenol A oligocarbonate, pentabromo polyacrylate, brominated polystyrene. As organic phosphorus compounds the phosphorus compounds according to WO98/17720 (PCT/EP/05705) are suitable, for example triphenyl phosphate (TPP), resorcinol-bis-(diphenyl phosphate) including oligomers (RDP) as well as bisphenol-A-bis-diphenyl phosphate including oligomers (BDP), melamine phosphate, melamine pyrophosphate, melamine polyphosphate and mixtures thereof. Suitable nitrogen compounds are in particular melamine and melamine cyanurate. Suitable as synergists are for example antimony compounds, in particular antimony trioxide and antimony pentoxide, zinc compounds, tin compounds such as for example tin stannate and borates. Carbon-forming agents and tetrafluoroethylene polymers may also be added.

Component E

Suitable aromatic polycarbonates and/or aromatic polyester carbonates of component E according to the invention are known in the literature or can be produced by methods known in the literature (for the production of aromatic polycarbonates see for example Schnell, “Chemistry and Physics of Polycarbonates”, Interscience Publishers, 1964, as well as DE-AS 1 495 626, DE-A 2 232 877, DE-A 2 703 376, DE-A 2 714 544, DE-A 3 000 610, DE-A 3 832 396; for the production of aromatic polyester carbonates see for example DE-A 3 077 934).

The production of aromatic polycarbonates is carried out for example by reacting diphenols with carbonic acid halides, preferably phosgene and/or with aromatic dicarboxylic acid dihalides, preferably benzenedicarboxylic acid dihalides, by the phase boundary process, optionally with the use of chain terminators, for example monophenols, and optionally with the use of trifunctional or more than trifunctional branching agents, for example triphenols or tetraphenols.

Diphenols for the production of the aromatic polycarbonates and/or aromatic polyester carbonates are preferably those of the formula (V)

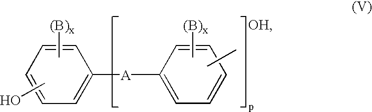

wherein

A denotes a single bond, C₁-C₅ alkylene, C₂-C₅ alkylidene, C₅-C₆ cycloalkylidene, —O—, —SO—, —CO—, —S, —SO₂—, C₆-C₁₂ arylene, onto which further aromatic rings optionally containing heteroatoms may be condensed,

or a radical of the formula (Va) or (Vb)

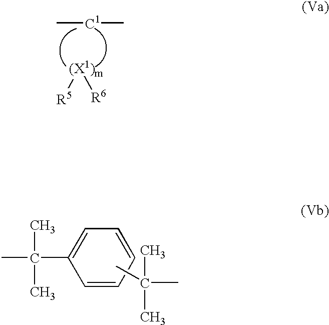

B in each case denotes C₁-C₁₂ alkyl, preferably methyl, or halogen, preferably chlorine and/or bromine,

x is in each case independently of one another 0, 1 or 2,

P is 0 or 1, and

R⁵ and R⁶ may be chosen individually for each X¹, and independently of one another denote hydrogen or C₁-C₆ alkyl, preferably hydrogen, methyl or ethyl,

X¹ denotes carbon, and

m is an integer from 4 to 7, preferably 4 or 5, with the proviso that on at least one atom X¹, R⁵ and R⁶ are simultaneously alkyl.

Preferred diphenols are hydroquinone, resorcinol, dihydroxy-diphenols, bis-(hydroxyphenyl)-C₁-C₅-alkanes, bis-(hydroxyphenyl)-C₅-C₆-cycloalkanes, bis-(hydroxyphenyl)-ethers, bis-(hydroxyphenyl)-sulfoxides, bis-(hydroxyphenyl)-ketones, bis-(hydroxyphenyl)-sulfones, and α,α-bis-(hydroxyphenyl)-diisopropylbenzenes as well as their nuclear-brominated and/or nuclear-chlorinated derivatives.

Particularly preferred diphenols are 4,4′-dihydroxydiphenyl, bisphenol A, 2,4-bis(4-hydroxyphenyl)-2-methylbutane, 1,1-bis(4-hydroxyphenyl)-cyclohexane, 1,1-bis(4-hydroxyphenyl)-3,3,5-trimethylcyclohexane, 4,4′-dihydroxydiphenyl sulfide, 4,4′-dihydroxydiphenyl sulfone as well as their dibrominated and tetrabrominated or chlorinated derivatives, such as for example 2,2-bis-(3-chloro-4-hydroxy-phenyl)propane, 2,2-bis-(3,5-dichloro-4-hydroxyphenyl)-propane or 2,2-bis-(3,5-dibromo-4-hydroxyphenyl)propane. 2,2-bis-(4-hydroxyphenyl)propane (bisphenol A) is particularly preferred.

The diphenols may be used individually or as arbitrary mixtures.

The diphenols are known in the literature and may be obtained by processes known in the literature.

Suitable chain terminators for the production of the thermoplastic, aromatic polycarbonates include for example phenol, p-chlorophenol, p-tert.-butylphenol or 2,4,6-tribromophenol, as well as long-chain alkylphenols such as 4-(1,3-tetramethylbutyl)phenol according to DE-A 2 842 005, or monoalkylphenols or dialkylphenols with a total of 8 to 20 C atoms in the alkyl substituents, such as 3,5-di-tert.-butylphenol, p-iso-octylphenol, p-tert.-octylphenol, p-dodecylphenol, and 2-(3,5-dimethylheptyl)phenol and 4-(3,5-dimethylheptyl)phenol. The amount of chain terminators used is generally between 0.5 mole % and 10 mole %, referred to the molar sum of the diphenols used in each case.

The thermoplastic aromatic polycarbonates have mean, weight average molecular weights (M_{w}, measured for example by ultracentrifugation or light-scattering measurements) of 10,000 to 200,000, preferably 15,000 to 80,000.

The thermoplastic, aromatic polycarbonates may be branched in a known manner, and more specifically preferably by the incorporation of 0.05 to 2.0 mole %, referred to the sum of the diphenols used, of trifunctional or more than trifunctional compounds, for example those with three or more than three phenolic groups.

Also suitable are homopolycarbonates as well as copolycarbonates. For the production of copolycarbonates according to the invention, as component A there may also be used 1 to 25 wt. %, preferably 2.5 to 25 wt. % (referred to the total amount of diphenols used) of polydiorgano-siloxanes with hydroxy-aryloxy terminal groups. These are known (see for example U.S. Pat. No. 3,419,634) or can be produced by methods known in the literature. The production of polydiorganosiloxane-containing copoly-carbonates is described for example in DE-A 3 334 782.

Preferred polycarbonates include, in addition to bisphenol A homopolycarbonates, also the copolycarbonates of bisphenol A with up to 15 mole %, referred to the molar sums of diphenols, of diphenols other than preferred and/or particularly preferred diphenols, especially up to 15 mole % of 2,2-bis(3,5-dibromo-4-hydroxyphenyl)propane.

Aromatic dicarboxylic acid dihalides for the production of aromatic polyester carbonates are preferably the diacid dichlorides of isophthalic acid, terephthalic acid, diphenylether-4,4′-dicarboxylic acid and naphthalene-2,6-dicarboxylic acid.

Particularly preferred are mixtures of the diacid dichlorides of isophthalic acid and terephthalic acid in a ratio of between 1:20 and 20:1.

In the production of polyester carbonates a carbonic acid halide, preferably phosgene, is in addition co-used as bifunctional acid derivative.

Suitable chain terminators for the production of the aromatic polyester carbonates include, apart from the already mentioned monophenols, also their chlorinated carbonic acid esters as well as the acid chlorides of aromatic monocarboxylic acids, which may optionally be substituted by C₁-C₂₂ alkyl groups or by halogen atoms, as well as aliphatic C₂-C₂₂ monocarboxylic acid chlorides.

The amount of chain terminators is in each case 0.1 to 10 mole %, referred in the case of phenolic chain terminators to moles of diphenols, and in the case of monocarboxylic acid chloride chain terminators to moles of dicarboxylic acid dichlorides.

The aromatic polyester carbonates may also include incorporated aromatic hydroxycarboxylic acids.

The aromatic polyester carbonates may be linear as well as branched in a known manner (see in this connection also DE-A 2 940 024 and DE-A 3 007 934).

As branching agents there may be used for example trifunctional or polyfunctional carboxylic acid chlorides such as trimesic acid trichloride, cyanuric acid trichloride, 3,3′-4,4′-benzophenone tetracarboxylic acid tetrachloride, 1,4,5,8-naphthalene-tetracarboxylic acid tetrachloride or pyromellitic acid tetrachloride in amounts of 0.01 to 1.0 mole % (referred to the dicarboxylic acid dichlorides that are used), or trifunctional or polyfunctional phenols such as phloroglucinol, 4,6-dimethyl-2,4,6-tri-(4-hydroxyphenyl)-heptene-2,4,4-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenylmethane, 2,2-bis[4,4-bis-(4-hydroxyphenyl)-cyclohexyl]-propane, 2,4-bis-(4-hydroxyphenylisopropyl)-phenol, tetra-(4-hydroxyphenyl)-methane, 2,6-bis-(2-hydroxy-5-methylbenzyl)-4-methylphenol, 2-(4-hydroxy-phenyl)-2-(2,4-dihydroxyphenyl)-propane, tetra-(4-[4-hydroxyphenylisopropyl]-phenoxy)-methane, 1,4-bis-[4,4′-dihydroxytriphenyl)-methyl]-benzene, in amounts of 0.01 to 1.0 mole %, referred to the diphenols that are used. Phenolic branching agents may be added together with the diphenols, while acid chloride branching agents may be added together with the acid dichlorides.

In the thermoplastic, aromatic polyester carbonates the proportion of carbonate structural units may be varied as desired. Preferably the proportion of carbonate groups is up to 100 mole %, in particular up to 80 mole %, particularly preferably up to 50 mole %, referred to the sum total of ester groups and carbonate groups. The ester fraction as well as the carbonate fraction of the aromatic polyester carbonates may be present in the form of blocks or may be statistically distributed in the polycondensate.

The relative solution viscosity (ηᵣₑₗ) of the aromatic polycarbonates and polyester carbonates is in the range 1.18 to 1.4, preferably 1.20 to 1.32 (measured in solutions containing 0.5 g of polyester or polyestercarbonates in 100 ml of methylene chloride solution at 25° C.).

The thermoplastic, aromatic polycarbonates and polyester carbonates may be used alone or in arbitrary mixtures with one another.

Component F

The component F includes one or more graft polymers of

F.1 5 to 95 wt. %, preferably 30 to 90 wt. %, of at least one vinyl monomer grafted on

F.2 95 to 5 wt. %, preferably 70 to 10 wt. %, of one or more graft bases having glass transition temperatures of <10° C., preferably <0° C., particularly preferably <−20° C.

The graft base F.2 generally has a mean particle size (d₅₀ value) of 0.05 to 10 μm, preferably 0.1 to 5 μm, particularly preferably 0.2 to 1 μm.

Monomers F.1 are preferably mixtures of

F.1.1 50 to 99 parts by weight of vinyl aromatic compounds and/or nuclear-substituted vinyl aromatic compounds (such as for example styrene, α-methylstyrene, p-methylstyrene, p-chlorostyrene) and/or methacrylic acid (C₁-C₈) alkyl esters (such as for example methyl methacrylate, ethyl methacrylate) and

F.1.2 1 to 50 parts by weight of vinyl cyanides (unsaturated nitriles such as acrylonitrile and methacrylonitrile) and/or (meth)acrylic acid (C₁-C₈) alkyl esters (such as for example methyl methacrylate, n-butyl acrylate, t-butyl acrylate) and/or derivatives (such as anhydrides and imides) of unsaturated carboxylic acids (for example maleic anhydride and N-phenylmaleimide).

Preferred monomers F.1.1 are selected from at least one of the monomers styrene, α-methylstyrene and methyl methacrylate, and preferred monomers F.1.2 are selected from at least one of the monomers acrylonitrile, maleic anhydride and methyl methacrylate.

Particularly preferred monomers are F.1.1 styrene, and F.1.2 acrylonitrile.

Suitable graft bases F.2 for the graft polymers F are for example diene rubbers, EP(D)M rubbers, i.e. those based on ethylene/propylene, and optionally diene, acrylate, polyurethane, silicone, chloroprene and ethylene/vinyl acetate rubbers.

Preferred graft bases F.2 are diene rubbers (for example based on butadiene, isoprene, etc.) or mixtures of diene rubbers or copolymers of diene rubbers or their mixtures with further copolymerisable monomers (for example according to F.1.1 and F.1.2), with the proviso that the glass transition temperature of the component F.2 is below 10° C., preferably <0° C., particularly preferably <−10° C.

Pure polybutadiene rubber is particularly preferred.

Particularly preferred polymers F are for example ABS polymers (emulsion, bulk and suspension ABS), such as are described for example in DE-A 2 035 390 (=U.S. Pat. No. 3,644,574) or in DE-A 2 248 242 (=GB-A 1 409 275) or in Ullmann, Enzyklopädie derTechnischen Chemie, Vol.19 (1980), p. 280 et seq. The gel proportion of the graft base F.2 is at least 30 wt. %, preferably at least 40 wt. % (measured in toluene).

The graft copolymers F are produced by free-radical polymerisation, for example by emulsion, suspension, solution or bulk polymerisation, preferably by emulsion or bulk polymerisation.

Particularly suitable graft rubbers are also ABS polymers that are produced by redox initiation with an initiator system of organic hydroperoxide and ascorbic acid according to U.S. Pat. No. 4,937,285.

Since in the graft reaction the graft monomers are as is known not necessarily completely grafted onto the graft base, according to the invention the term graft polymers B is also understood to mean those products that are obtained by (co)polymerisation of the graft monomers in the presence of the graft base and that are formed with the latter during the working-up.

Suitable acrylate rubbers according to F.2 of the polymers F are preferably polymers of acrylic acid alkyl esters, optionally with up to 40 wt. %, referred to F.2, of other polymerisable, ethylenically unsaturated monomers. The preferred polymerisable acrylic acid esters include C₁-C₈ alkyl esters, for example methyl, ethyl, butyl, n-octyl and 2-ethylhexyl esters; halogenated alkyl esters, preferably halogenated-C₁-C₈-alkyl esters such as chloroethyl acrylate, as well as mixtures of these monomers.

Monomers with more than one polymerisable double bond may be co-polymerised for the crosslinking. Preferred examples of crosslinking monomers are esters of unsaturated monocarboxylic acids with 3 to 8 C atoms and unsaturated monohydric alcohols with 3 to 12 C atoms or saturated polyols with 2 to 4 OH groups and 2 to 20 C atoms, such as for example ethylene glycol dimethacrylate, allyl methacrylate; multiply unsaturated heterocyclic compounds, such as for example trivinyl cyanurate and triallyl cyanurate; polyfunctional vinyl compounds such as divinylbenzenes and trivinylbenzenes; as well as triallyl phosphate and diallyl phthalate.

Preferred crosslinking monomers include allyl methacrylate, ethylene glycol dimethacrylate, diallyl phthalate and heterocyclic compounds that contain at least 3 ethylenically unsaturated groups.

Particularly preferred crosslinking monomers are the cyclic monomers triallyl cyanurate, triallyl isocyanurate, triacryloylhexahydro-s-triazine, and triallylbenzenes. The amount of the crosslinking monomers is preferably 0.02 to 5 wt. %, in particular 0.05 to 2 wt. %, referred to the graft base F.2.

In the case of cyclic crosslinking monomers containing at least 3 ethylenically unsaturated groups, it is advantageous to restrict the amount to below 1 wt. % of the graft base F.2.

Preferably “other” polymerizable ethylenically unsaturated monomers that in addition to the acrylic acid esters may optionally serve for the production of the graft base F.2 include for example acrylonitrile, styrene, α-methylstyrene, acrylamides, vinyl C₁-C₆ alkyl ethers, methyl methacrylate, and butadiene. Preferred acrylate rubbers as graft base F.2 are emulsion polymers that have a gel content of at least 60 wt. %.

Further suitable graft bases according to F.2 are silicone rubbers with graft-active sites, such as are described in DE-A 3 704 657, DE-A 3 704 655, DE-A 3 631 540 and DE-A 3 631 539.

The gel content of the graft base F.2 is measured at 25° C. in a suitable solvent (M. Hoffmann, H. Krömer, R. Kuhn, Polymeranalytik I und II, Georg Thieme-Verlag, Stuttgart 1977).

The mean particle diameter d₅₀ is the diameter above and below which in each case 50 wt. % of the particles lie, and may be determined by means of ultracentrifuge measurements (W. Scholtan, H. Lange, Kolloid, Z. und Z. Polymere 250 (1972), 782-1796).

Component G

The component G are additives. Conventional additives are for example stabilizers, (for example UV stabilizers, thermal stabilizers, gamma radiation stabilizers), antistatics, flow auxiliaries, mold release agents, flame-proofing additives, emulsifiers, nucleating agents, plasticisers, lubricants, coloring agents and pigments. The aforementioned and further suitable additives are described for example in Gächter, Müller, Kunststoff-Additive, 3^{rd} Edition, Hanser-Verlag, Munich, Vienna, 1989. The additives may be used alone or as a mixture, or in the form of master batches.

As stabilizers there may for example be used sterically hindered phenols, hydroquinones, aromatic secondary amines such as diphenylamines, substituted resorcinols, salicylates, benzotriazoles and benzophenones, as well as variously substituted representatives of these groups and mixtures thereof.

As pigments there may be used for example titanium dioxide, ultramarine blue, iron oxide, carbon black, phthalocyanines, quinacridones, perylenes, nigrosin and anthraquinones.

As nucleating agents there may for example be used sodium phenyl phosphinate, aluminium oxide, silicon dioxide as well as, preferably, talcum.

As lubricants and mold release agents there may be used ester waxes, pentaerythritol stearate (PETS), long-chain fatty acids (for example stearic acid or behenic acid), their salts (for example Ca or Zn stearate) as well as amide derivatives (e.g. ethylene bis-stearylamide) or montan waxes (mixtures of straight-chain, saturated carboxylic acids with chain lengths of 28 to 32 C atoms) as well as low molecular weight polyethylene and/or polypropylene waxes.

As plasticizers there may be used for example phthalic acid dioctyl ester, phthalic acid dibenzyl ester, phthalic acid butylbenzyl ester, hydrocarbon oils, N(n-butyl)benzene sulfonamide.

The production of the compositions according to the invention is carried out according to methods known per se by mixing the components. The components are mixed in the corresponding proportions by weight. The mixing of the components preferably takes place at room temperature (preferably 0 to 40° C.) and/or at temperatures of 220 to 330° C. by jointly blending, mixing, kneading, extruding or rolling the components. It may be advantageous to pre-mix individual components. It may furthermore be advantageous to produce molded parts or semi-finished products directly from a physical mixture (dry blend) of pre-mixed components and/or individual components, prepared at room temperature (preferably 0 to 40° C.).

The invention also provides processes for the production of the compositions, and their use for the production of molded articles as well as the molded articles themselves.

### EXAMPLES

Phosphorous acid ester: the phosphorous acid ester in Table 1 is phosphorous acid-(1-methethylidene)di-4,1-phenylene-tetrakis(3-ethyl-(3-oxetanyl)-methyl)ester (CA:53184-75-1)

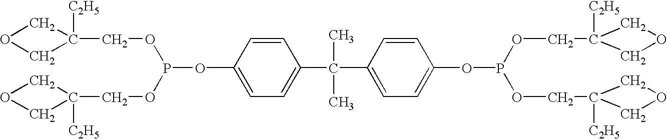

The phosphorous acid ester in Table 1 is used as a master batch (10%) in polybutylene terephthalate (PBT) from Bayer AG, Leverkusen, Germany, having an intrinsic viscosity IV=0.95 cm³/g. The actual amount of phosphorous acid ester referred to the overall composition is shown in Table 1.

PBT: the PBT that is used is, with the exception of the small PBT fraction of the 10% phosphorous acid ester master batch (10%), a highly viscous PBT from Bayer AG having an intrinsic viscosity IV=1.42 cm³/g (Pocan B 1800). The total amount of PBT is given in Table 1.

The phosphorous acid ester master batch and the highly viscous PBT are physically mixed in the quantitative ratios given in Table 1 and this mixture (dry blend) is injection molded in an Arburg 320-210-500 type injection molding machine at a stock temperature of ca. 260° C. and a tool temperature of ca. 80° C. to form test specimens (3 mm thick according to ISO 527). All the investigations listed in Table 1 were carried out on the aforementioned test specimens.

The measurement of the intrinsic viscosity was performed in a solution of 5 g PBT dissolved in 1 liter of phenol/ortho-dichlorobenzene (50 wt. %/50 wt. %) at 25° C.

The determination of the COOH terminal groups was carried out by dissolving sample material in cresol/chloroform followed by photometric titration.

The elongation at break is measured in accordance with the tensile test of DIN 53455.

The hydrolysis tests are carried out by storing the aforementioned test specimens in a Varioklav steam sterilizer (type 300/400/500 EP-Z) at 100° C. in a saturated steam atmosphere.

As can be seen from Table 1, the molding compositions according to the invention (Examples 1 and 2) after storage in steam for 240 hours have lower COOH terminal group contents than the comparison examples 1 to 5. The molding compositions according to the invention (Examples 1 and 2) after storage in steam for 240 hours have higher elongation at break values in the tensile test than the comparison examples 1 to 5. Lower COOH terminal group contents and higher elongation at break values after storage in steam indicate less polymer damage due to polymer degradation and demonstrate the improved hydrolysis resistance.

TABLE I

| | | Comp. | Comp. | Comp. | Ex. | Ex. | Comp | |
|---|---|---|---|---|---|---|---|---|
| | | 1 | 2 | 3 | 1 | 2 | 4 | Comp 5 |
| PBT | % | 100 | 99.98 | 99.96 | 99.95 | 99.94 | 99.9 | 99.85 |
| phosphorous | | 0 | 0.02 | 0.04 | 0.06 | 0.07 | 0.1 | 0.15 |
| acid ester | | | | | | | | |
| COOH | mmole/ | 33 | 28 | 22 | 22 | 20 | 21 | 21 |
| terminal | kg | | | | | | | |
| groups | | | | | | | | |
| injection- | | | | | | | | |
| fresh, before | | | | | | | | |
| hydrolysis | | | | | | | | |
| COOH | mmole/ | 96 | 77 | 71 | 65 | 60 | 69 | 82 |
| terminal | kg | | | | | | | |
| groups after | | | | | | | | |
| 240 hours' | | | | | | | | |
| hydrolysis | | | | | | | | |
| Elongation at | % | 247 | 238 | 233 | 248 | 253 | 282 | 277 |
| break | | | | | | | | |
| injection- | | | | | | | | |
| fresh, before | | | | | | | | |
| hydrolysis | | | | | | | | |
| Elongation at | % | 2 | 5 | 8 | 13 | 17 | 11 | 1 |
| break after | | | | | | | | |
| 240 hours' | | | | | | | | |
| hydrolysis | | | | | | | | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A molding composition containing
A) polyalkylene terephthalate and
B) 0.041 to 0.095 pbw of at least one of B.1) and B.2 , where B.1) is a phosphorous acid ester the molecular structure of which contains at least one oxetane group and at least one radical of a dihydric or polyhydric phenol, and where B.2 is an ester of phosphorous acid the molecular structure of which contains at least one phosphorus-bound hydroxyl group (P—OH) and at least one radical of a dihydric or polyhydric phenol, said pbw relating to 100 parts by weight of the total composition containing A) and B).

2. The composition of claim 1 further containing at least one further component selected from C) fillers and/or reinforcing agents, D) flame-proofing additives, E) aromatic poly(ester)carbonate, F) elastomeric modifiers, and G) conventional additives.

3. The composition of claim 1 wherein said B is present in an amount of 0.051 to 0.075 pbw.

4. The composition of claim 1 wherein said B is present in an amount of 0.055 to 0.065 pbw.

5. The composition of claim 2 wherein C is present in an amount of 6 to 69 pbw.

6. The composition of claim 2 wherein D is present in an amount of 5 to 25 pbw.

7. The composition of claim 2 wherein E is present in an amount of 6 to 69 pbw.

8. The composition of claim 2 wherein F is present in an amount of 5 to 29 pbw.

9. The composition of claim 2 wherein G is present in an amount of 0.01 to 5 pbw.

10. The composition of claim 1 wherein phosphorous acid esters conforms to formula (I) 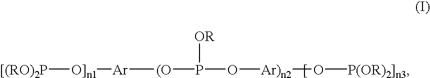
in which
n₁ is 1 or an integer>1,
n₂ is 0 or an integer>0,
n₃ is 1 or an integer>1,
R denotes alkyl, aralkyl, cycloalkyl, aryl or heteroaryl, wherein at least one of the radicals R denotes the radical of a monohydric alcohol containing at least one oxetane group Y, and
Ar denotes aryl and wherein for n₂≠0, Ar may be identical or different.

11. The composition according to claim 10, wherein Y is the heterocyclic radical 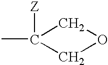
wherein
Z denotes a member selected from the group consisting of H, CH₃, C₂H₅, n-C₅H₁₁, —CH₂—C₅H₁₁, —CH₂—O—C₆H₁₃ and CH₂—O—C₂H₅.

12. The composition according to claim 10, wherein Ar corresponds to a radical of the formula (II) 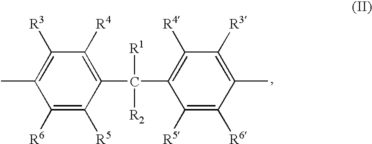
wherein
R¹ and R² are identical or different and denote H, C₁-C₁₈ alkyl, mononuclear or polynuclear C₃-C₆ cycloalkyl, or mononuclear or polynuclear C₆-C₁₈ aryl,
R³, R^{3′}, R⁴, R^{4′}, R⁵, R^{5′}, R⁶ and R^{6′} are identical or different and denote H, C₁-C₁₈ alkyl, mononuclear or polynuclear C₃-C₆ cycloalkyl, mononuclear or polynuclear C₆-C₁₈ aryl, C₁-C₁₈ alkoxy, C₁-C₁₈ aryloxy or halogen.

13. The composition according to claim 1 wherein B conforms to formula (IV) 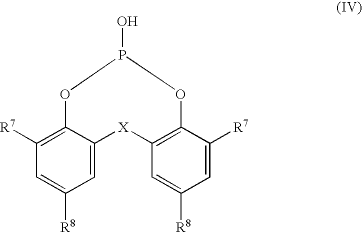
wherein
R⁷ and R⁸ are identical or different and denote C₁-C₉ alkyl, C₅-C₆ cycloalkyl, C₇-C₉ aralkyl or C₆-C₁₀ aryl and
X denotes —S— or R⁹—CH where R⁹ denotes hydrogen, C₁-C₆ alkyl or C₅-C₆ cycloalkyl.

14. The composition according to claim 2 wherein component F is one or more graft polymers of
F.1 5-95 parts by weight (relative to 100 parts by weight of F) of at least one vinyl monomer grafted on
F.2 95-5 parts by weight (relative to 100 parts by weight of F) of one or more graft bases having glass transition temperatures of <10° C.

15. A method of using the composition according to claim 1 comprising producing molded parts.

16. A molded article comprising the composition of claim 1.
